(19) United States
(12) Patent Application Publication
(10) Pub. No.: US 2003/0210255 A1
(43) Pub. Date: Nov. 13, 2003

(54) Image display processing apparatus, image display processing method, and computer program

(75) Inventor: Norikazu Hiraki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/386,574

(22) Filed: Mar. 13, 2003

(30) Foreign Application Priority Data
Mar. 26, 2002 (JP) 2002-086767

(51) Int. Cl. G09G 5/00

(52) U.S. Cl. 345/684

(57) ABSTRACT

An image display processing apparatus for scrolling through an image on a display includes a controller unit, a scroll information generator, and an image display controller. The controller unit includes a controller that is operable by a user and a sensor that detects the position and/or attitude of the controller in a three-dimensional space. The scroll information generator determines a scrolling mode of the image on the display based on the position and/or attitude of the controller in the three-dimensional space. The image display controller scrolls through the image on the display in accordance with the scrolling mode determined in the scroll information generator to update the displayed image.

### BACKGROUND OF THE INVENTION

1. Field of the Invention

The present invention relates to image display processing apparatuses, image display processing methods, and computer programs and, more particularly, to an image display processing apparatus, an image display processing method, and a computer program for scrolling through an image on a display, such as an LCD (liquid crystal display), in accordance with the movement of a controller.

2. Description of the Related Art

A keyboard, scroll switches provided on a controller, a mouse, or the like is generally used to scroll through an image on a display of, for example, a PC or a game apparatus, that is, to move and update the image on the display.

Such a scrolling process should be performed in accordance with a predetermined procedure, so that a user who is familiar with the operation of the PC (personal computer) and so on can scroll through the image without problems. However, the scrolling process is not user-friendly for users, such as a child, who are unfamiliar with the operation of the PC or a game apparatus.

FIG. 1 shows an exemplary structure of a display system targeted at, for example, children. In the display system in FIG. 1, a user processes information on a display 102 by using a controller 101 having a sensor for detecting the position and attitude of the controller 101.

With such a system having a controller, various kinds of operations on the display 102 are generally performed by making a local coordinate system of the controller 101 that serves as the sensor corresponding with a screen coordinate system and a coordinate system for models, such as a map or a three-dimensional virtual world, on the display 102 to directly interact with objects on the display 102 with the controller 101.

For example, referring to FIG. 2A, such direct interaction that a button 103 on the display 102 is pressed when the controller 101 moves onto the button 103 is implemented. Interacting with the objects on the display with the controller itself, instead of through a mouse cursor as in a general-purpose mouse, is referred to as “direct interaction”.

Correspondence of the sensor coordinate system with the screen coordinate system and the model coordinate system also allows a shadow 104 of the controller 101 to be virtually displayed on the display 102 (FIG. 2B). This is also one kind of direct interaction.

When the map or the three-dimensional virtual world cannot be entirely displayed on a screen, it is necessary to scroll through the image in order to access the image portion that is not displayed on the screen. Scrolling methods in the system described above includes a method in which pressing arrows (up, down, right, and left arrows) on a button provided at an arbitrary position in the screen with a controller causes scrolling toward the directions corresponding to the arrows on the button to be operated.

Although such a method has been commonly used, a procedure of pressing an indirect object, or the button, is troublesome. Provision of the button on the screen reduces the available area for the display image and also makes the screen complicated. A scroll bar may be provided at one side of the screen to perform the scrolling by operating the scroll bar with the controller. However, this method also poses problems, such as the occupation of the screen area and the complicated screen.

Although physical devices, such as a joystick, a track ball, a button, or a jog dial, may be added to the display or the controller for scrolling, this structure has no use when no scrolling is performed and also increases the production cost.

### SUMMARY OF THE INVENTION

Accordingly, it is an object of the present invention to provide an image display processing apparatus, an image display processing method, and a computer program that are capable of scrolling through an image on a display of, for example, a PC or a game apparatus by simple operation of a controller.

Specifically, it is an object of the present invention to provide an image display processing apparatus, an image display processing method, and a computer program that are capable of scrolling through an image on a display of, for example, a PC or a game apparatus based on detected attitude and movement information of a controller that a user, such as a child, can hold.

The present invention provides, in its first aspect, an image display processing apparatus for scrolling through an image on a display. The image display processing apparatus includes a controller unit, a scroll information generator, and an image display controller. The controller unit includes a controller that is operable by a user and a sensor that detects the position and/or attitude of the controller in a three-dimensional space. The scroll information generator determines a scrolling mode of the image on the display based on the position and/or attitude of the controller in the three-dimensional space. The image display controller scrolls through the image on the display in accordance with the scrolling mode determined in the scroll information generator to update the displayed image.

It is preferable that the scroll information generator determine whether the controller is in a right-tilting state, a left-tilting state, or a vertical state and determine whether scrolling is performed based on the presence of a state transition between the three states.

The scroll information generator may determine whether the controller is in a right-tilting state, a left-tilting state, or a vertical state and may determine whether scrolling is performed based on the presence of a state transition between the right-tilting state and the left-tilting state.

The image display processing apparatus preferably further includes a converter for converting the position and/or attitude of the controller into information corresponding to a screen coordinate system with respect to the surface of the display. The scroll information generator may determine the scrolling mode of the image on the display based on the converted position and/or attitude of the controller in the screen coordinate system.

The scroll information generator preferably determines a scroll direction based on an orientation of the controller.

The scroll information generator may determine a scroll direction based on a tilt direction of the controller.

The scroll information generator preferably determines whether the controller is within a predetermined active area and determines to perform scrolling when the controller is within the predetermined active area.

The active area may be defined as an area that is spaced apart, in the vertical direction, from the surface of the display by a distance greater than a predetermined distance.

The active area may be defined as an area that is spaced apart, in the horizontal direction, from the surface of the display by a distance greater than a predetermined distance.

The active area may be defined as an area that is spaced apart from the center of the display by a distance greater than a predetermined distance.

The active area may be defined as an area that is within a predetermined distance from the display.

The active area may be defined as an area in the three-dimensional space corresponding to the image on the display.

The scroll information generator preferably determines a scroll speed or a scroll distance based on the position of the controller within the active area.

The sensor may be either an imaging system, a magnetic sensor, or an ultrasonic sensor.

The present invention provides, in its second aspect, an image display processing method for scrolling through an image on a display. The processing method includes a step of detecting the position and/or attitude of a controller in a three-dimensional space by a sensor, the controller being operated by a user; a scroll information generating step of determining a scrolling mode of the image on the display based on the position and/or attitude of the controller in the three-dimensional space; and an image display control step of scrolling through the image on the display in accordance with the scrolling mode determined in the scroll information generating step to update the displayed image.

It is preferable that the scroll information generating step include a step of determining whether the controller is in a right-tilting state, a left-tilting state, or a vertical state and determining whether scrolling is performed based on the presence of a state transition between the three states.

The scroll information generating step may include a step of determining whether the controller is in a right-tilting state, a left-tilting state, or a vertical state and determining whether scrolling is performed based on the presence of a state transition between the right-tilting state and the left-tilting state.

The image display processing method preferably further includes a converting step of converting the position and/or attitude of the controller into information corresponding to a screen coordinate system with respect to the surface of the display. The scroll information generating step may determine the scrolling mode of the image on the display based on the converted position and/or attitude of the controller in the screen coordinate system.

The scroll information generating step preferably includes a step of determining a scroll direction based on an orientation of the controller.

The scroll information generating step may include a step of determining a scroll direction based on a tilt direction of the controller.

The scroll information generating step preferably determines whether the controller is within a predetermined active area and determines to perform scrolling when the controller is within the predetermined active area.

The active area may be defined as an area that is spaced apart, in the vertical direction, from the surface of the display by a distance greater than a predetermined distance.

The active area may be defined as an area that is spaced apart, in the horizontal direction, from the surface of the display by a distance greater than a predetermined distance.

The active area may be defined as an area that is spaced apart from the center of the display by a distance GUI components, such as a button or a scroll bar, on the display and for the addition of devices, such as a joystick or a track ball, to a PC or a game machine or to the controller itself in order to perform scrolling of an image on the display. Since the scrolling through the image is performed based on the position and/or attitude of the controller, a display scrolling structure that permits user-friendly operation for users who are not familiar with the operation of the PC or the game machine is realized.

With these features, a tilt state transition of the controller is detected and scrolling through the image on the display is performed based on the detected transition information, so that it appears as if the controller is walking on the display and the scrolling process reflecting such a situation is implemented.

With these features, since the position of the controller is detected and scrolling through the image on the display is performed based on the detected position, an easy scrolling process without complicated operation is realized.

Additionally, with these features, the scroll direction, the scroll distance, and the scroll speed are determined depending on the movement or position of the controller, so that a user can enjoy a natural and easy scrolling process.

A computer program according to the present invention greater than a predetermined distance.

The active area may be defined as an area that is within a predetermined distance from the display.

The active area may be defined as an area in the three-dimensional space corresponding to the image on the display.

The scroll information generating step preferably includes a step of determining a scroll speed or a scroll distance based on the position of the controller within the active area.

The sensor may be either an imaging system, a magnetic sensor, or an ultrasonic sensor.

The present invention provides, in its third aspect, a computer program for rendering a computer system to perform scrolling through an image on a display. The computer program includes a step of detecting the position and/or attitude of a controller in a three-dimensional space by a sensor, the controller being operated by a user; a scroll information generating step of determining a scrolling mode of the image on the display based on the position and/or attitude of the controller in the three-dimensional space; and an image display control step of scrolling through the image on the display in accordance with the scrolling mode determined in the scroll information generating step to update the displayed image.

These features eliminate the need for the provision of can be supplied in a computer readable format to a general-purpose computer system that can execute various program codes via a storage medium, such as a CD, an FD, or an MO, or via a communication medium, such as a network. The computer system receives such a computer program in a computer readable format and performs processing depending on the computer program.

The above and other objects, features, and advantages of the present invention will become clear from the following description of the preferred embodiments taken in conjunction with the accompanying drawings. A system means, in this specification, a logical combination including a plurality of units such that all of the units in each structure are not limitedly incorporated in the same casing.

### BRIEF DESCRIPTION OF THE DRAWINGS

FIG. 1 shows an exemplary structure of a display system with a controller;

FIGS. 2A and 2B are diagrams showing exemplary operating modes in the display system with a controller;

FIG. 3 shows the structure of an image display processing apparatus according to an embodiment of the present invention;

FIG. 4 shows the structure of an image display processing apparatus according to another embodiment of the present invention, the image display processing apparatus using a magnetic sensor;

FIG. 5 shows the structure of an image display processing apparatus according to another embodiment of the present invention, the image display processing apparatus using an ultrasonic sensor;

FIG. 6 is a block diagram of an image display processing apparatus of the present invention;

FIG. 7 is a flowchart of the main routine in a process of an image display processing apparatus of the present invention;

FIG. 8A is a diagram describing a first embodiment of the scrolling method of the image display processing apparatus of the present invention, the controller tilting left when viewing from the front side thereof;

FIG. 8B is a diagram describing the first embodiment of the scrolling method of the image display processing apparatus of the present invention, the controller tilting right when viewing from the front side thereof;

FIG. 9 is a diagram describing a local coordinate system and a screen coordinate system used in the image display processing apparatus of the present invention;

FIG. 10 is a flowchart of a process in the first embodiment of the scrolling method of the image display processing apparatus of the present invention;

FIG. 11 is a flowchart of another process in the first embodiment of the scrolling method of the image display processing apparatus of the present invention;

FIG. 12 is a flowchart of a process in a second embodiment of the scrolling method of the image display processing apparatus of the present invention;

FIG. 13 is a diagram showing an example of an active area set in the second embodiment of the scrolling method of the image display processing apparatus of the present invention;

FIG. 14 is a diagram showing another example of the active area set in the second embodiment of the scrolling method of the image display processing apparatus of the present invention;

FIG. 15 is a diagram showing another example of the active area set in the second embodiment of the scrolling method of the image display processing apparatus of the present invention;

FIG. 16 is a diagram showing another example of the active area set in the second embodiment of the scrolling method of the image display processing apparatus of the present invention;

FIG. 17 is an exemplary scrolling mode in the second embodiment of the scrolling method of the image display processing apparatus of the present invention;

FIG. 18 is a diagram showing an example of the active area set in a third embodiment of the scrolling method of the image display processing apparatus of the present invention;

FIG. 19 is a flowchart of a process in the third embodiment of the scrolling method of the image display processing apparatus of the present invention;

FIG. 20 is a diagram describing a fourth embodiment of the scrolling method of the image display processing apparatus of the present invention;

FIG. 21 is a flowchart of a process in the fourth embodiment of the scrolling method of the image display processing apparatus of the present invention; and

FIG. 22 is a block diagram showing an exemplary hardware configuration of an image display processing apparatus of the present invention.

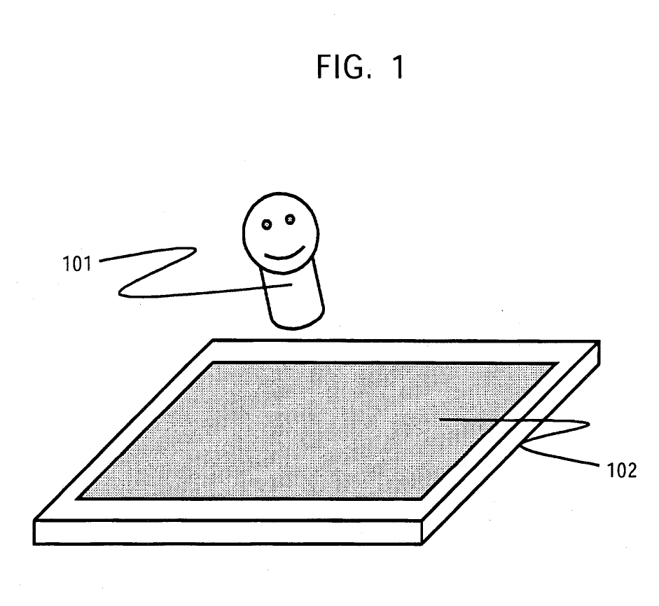

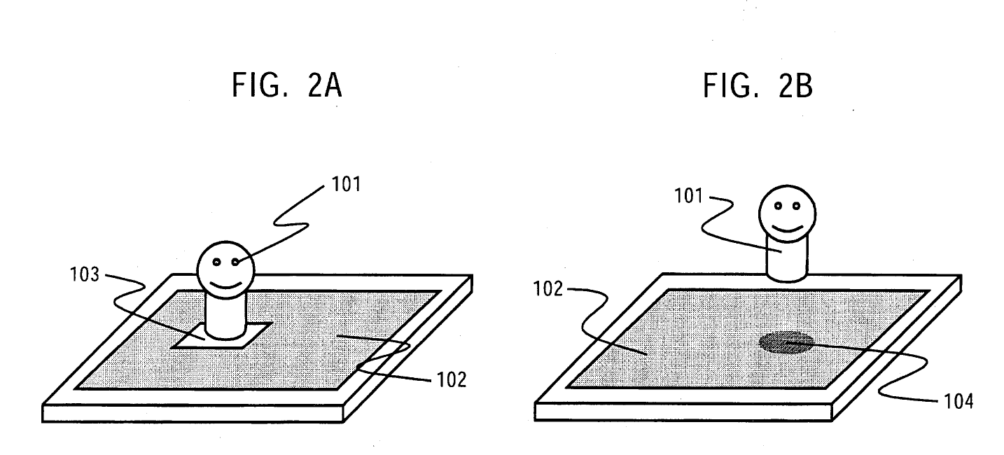

### DESCRIPTION OF THE PREFERRED EMBODIMENTS

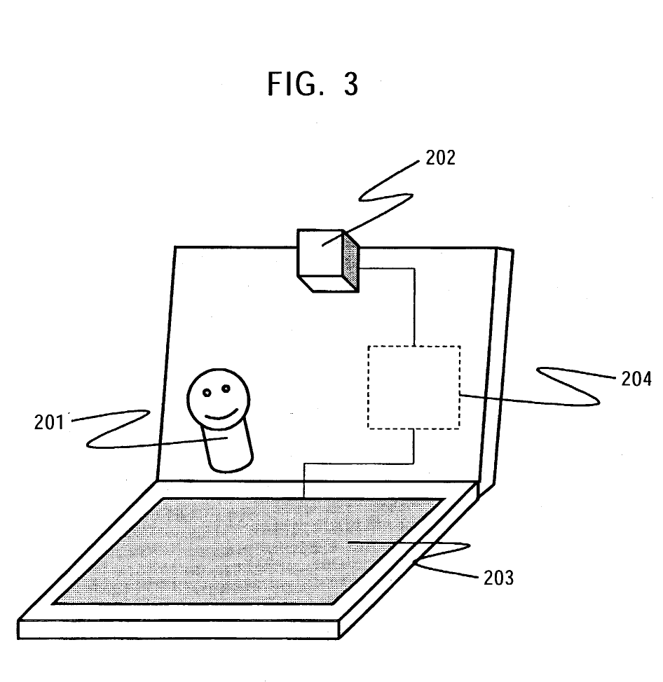

FIG. 3 shows the structure of an image display processing apparatus according to an embodiment of the present invention. The image display processing apparatus includes a controller 201 that is directly operated by a user, a sensor 202 for detecting the position and attitude of the controller 201, a display 203 (for example, an LCD) for displaying information, and a control unit 204 for performing a scrolling process based on the position and attitude of the controller 201 detected by the sensor 202 to generate an image to be displayed on the display 203.

Although the control unit 204 is incorporated in the display 203 in this image display processing apparatus, the control unit 204 may be provided separately from the display 203. In such a case, the sensor 202 and the display 203 may be connected to the control unit 204 via cable connection or wireless communication means, such as a wireless LAN and Bluetooth.

The sensor 202 is means for detecting the position and attitude of the controller 201 and it may be a camera that photographs the image of the controller 201, a magnetic sensor, an ultrasonic sensor, or the like. The arrangement of the sensor, the sensing area, sensing information, and so on depends on the type of sensor to be installed.

For example, when the sensor 202 is a camera, the sensor 202 photographs the controller 201 to determine the position and attitude of the controller 201 based on the photographed image information. Specifically, an identification (ID) mark, such as a barcode, that has a certain pattern is formed on the surface of the controller 201 and the pattern image is photographed by the camera serving as the sensor 202. By using a computer vision pattern matching method, the position and attitude of the controller 201 is determined.

Alternatively, light emitting means (for example, light emitting diode (LED)) that have flashing patterns representing certain IDs are provided on positions on the surface of the controller 201. The IDs of the light-emitting means and the positions thereof in the photographed image may be determined by analyzing flashing signals emitted from the light-emitting means based on the image photographed by the camera in order to detect the three-dimensional position and attitude of the controller 201. The sensor 202 serving as a camera may be provided at any position other than the position in FIG. 3.

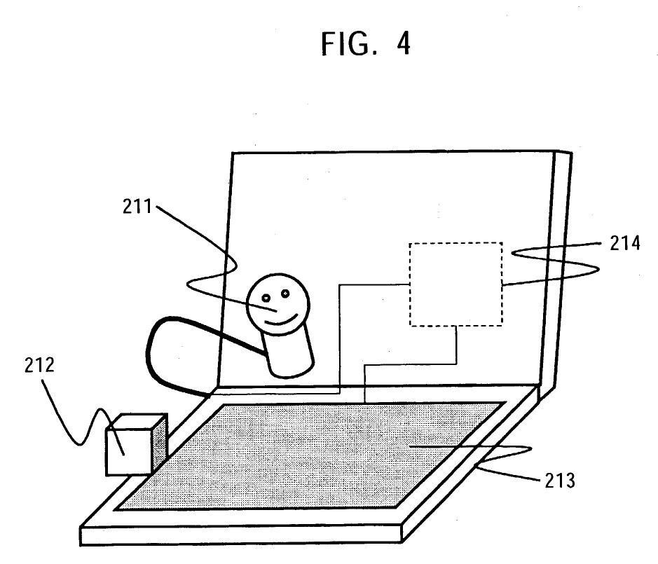

FIG. 4 shows the structure of an image display processing apparatus according to another embodiment of the present invention. The image display processing apparatus uses a magnetic sensing method for detecting the position and attitude of the controller 201.

The position and attitude of a controller and sensor 211 within a magnetic field generated by a magnetic field generator 212 is detected by the sensor that detects a magnetic field included in the controller. The magnetic field generator 212 is positioned depending on the sensing area and may be provided at any position other than the position in FIG. 4.

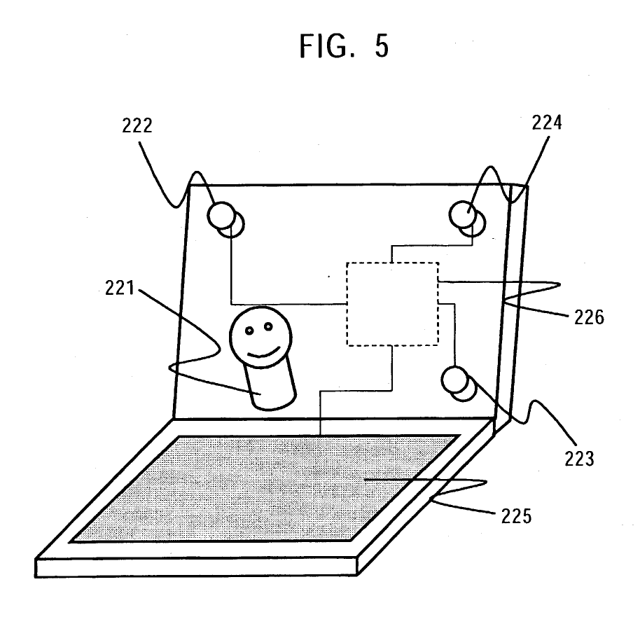

FIG. 5 shows the structure of an image display processing apparatus according to another embodiment of the present invention. The image display processing apparatus uses an ultrasonic sensing method for detecting the position and attitude of the controller 201. In this image display processing apparatus, ultrasonic sensors 222, 223, and 224 provided at different positions with respect to a display 225 each sense ultrasonic waves emerging from an ultrasonic generator included in a controller and ultrasonic generator 221. The position and attitude of the controller serving as an ultrasonic generator are detected at a time before the ultrasonic waves reach the ultrasonic sensors or with interference of the ultrasonic waves. The controller may generate plural types of ultrasonic waves and the ultrasonic sensor identifies and processes each type of ultrasonic waves. The number of ultrasonic sensors may be determined depending on the sensing mode and the sensing area. The ultrasonic sensors 222, 223, and 224 may be arranged at positions different from the positions in FIG. 5.

The structure for detecting and processing the position and attitude of the controller by using means other than analysis of images photographed by the camera, the magnetic sensor, or the ultrasonic sensors, all of which are described above with reference to FIGS. 3 to 5, may be embodied. In other words, image display processing apparatuses according to embodiments of the present invention may employ any means for detecting the position and attitude of the controller.

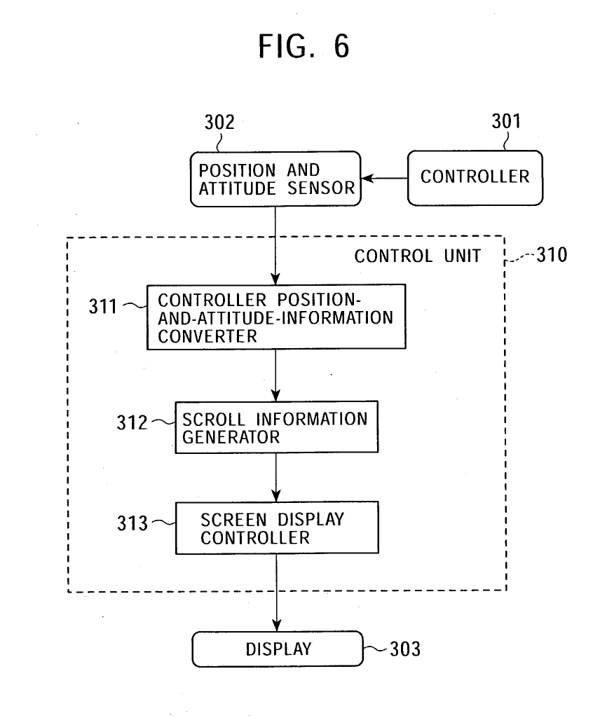

FIG. 6 is a block diagram of an image display processing apparatus according to an embodiment of the present invention. First, a position and attitude sensor 302 detects the position and attitude of a controller 301 that is directly operated by a user. The position and attitude sensor 302 is, for example, a camera, a magnetic sensor, or an ultrasonic sensor. Since the position and attitude of the controller 301 detected by the position and attitude sensor 302 are represented by the position and attitude in a sensor coordinate system that is uniquely defined by each sensor, a controller position-and-attitude-information converter 311 in a control unit 310 converts the position and attitude of the controller 301 in the sensor coordinate system to those in a screen coordinate system.

Next, a scroll information generator 312 determines whether scrolling is performed and a scrolling mode if the scrolling is performed, with the position and attitude of the controller 301 in the screen coordinate system. A screen display controller 313 generates an image to be displayed on a display 303 based on the scroll determination and the scrolling mode determined in the scroll information generator 312. Namely, the image on the display 303 is updated by using the scrolling mode when the scrolling is performed.

An application in which a user can enjoy a three-dimensional virtual world that is too large to be entirely displayed on a display will be described as an exemplary image display application. The user can interact with various objects existing in the three-dimensional virtual world with a controller. This three-dimensional virtual world provides tricks, such as some actions by three-dimensional objects when the controller moves on the three-dimensional objects displayed on the screen or sound that is generated depending on the position of the controller in the three-dimensional virtual world. However, the area that can entirely be displayed on the screen is limited; hence, in order to interact with the objects that are not displayed on the screen, it is necessary to scroll through the three-dimensional virtual world so that the objects to be interacted with are displayed on the screen. The scrolling method with the controller will now be described.

The number of dimensions required for representing the position and attitude of the controller varies depending on a scrolling method. Accordingly, a sensor that can detect the number of dimensions required for the scrolling method should at least be provided in some cases. Other input devices, such as a button or a dial, may be combined with the controller, if necessary, although scrolling methods according to the present invention do not employ such a combination.

The shape of the controller is not specifically limited and the controller can have any shape appropriate for the application. However, when a scrolling method in which the scroll direction depends on the orientation of the controller is employed, the controller is desirably shaped such that the front or top thereof can easily be recognized, as in an animal or an airplane. In the following embodiments, the controller has a shape in which the front of the controller can be defined. For example, for the controller 201 shown in FIGS. 3 to 5, the face of the controller faces toward the x axis, the right side thereof faces toward the y axis, and the top thereof faces toward the z axis. A camera, a magnetic sensor, and an ultrasonic sensor have structures in which the orientation of the controller can be recognized.

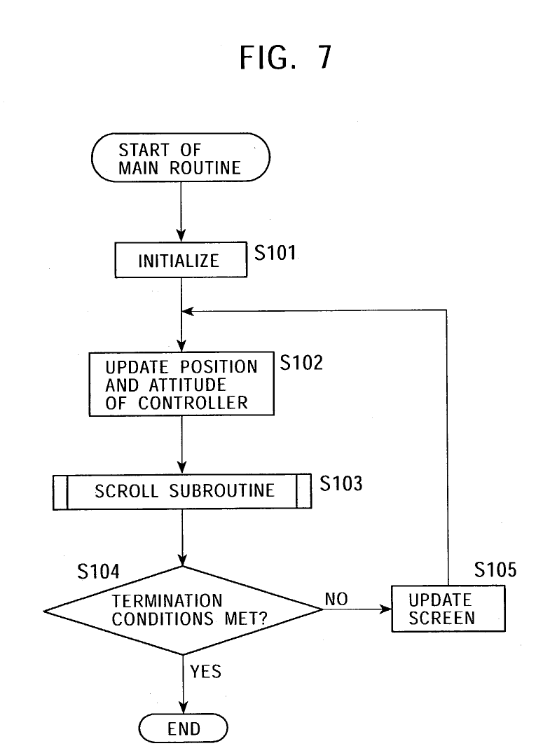

FIG. 7 is a flowchart of the main routine in a process of an image display processing apparatus according to an embodiment of the present invention. In Step S101, the main routine is initialized. Various initialization processes, such as initialization of a system state and reading of necessary files, are performed in this step. A controller can be initialized in this step, if required. In Step S102, the position and attitude of the controller detected by a sensor are converted into those in the screen coordinate system to update the current position and attitude of the controller.

In Step S103, the most suitable subroutine is selected among scroll subroutines described below. In some cases, a plurality of subroutines may be invoked or the subroutine to be invoked may be dynamically changed depending on a situation. The scroll subroutines will be described below in detail.

In Step S104, when termination conditions, such as a termination request from a user or an occurrence of a certain event, are met, the main routine terminates. When the termination conditions are not met in Step S104, in Step S105, the main routine updates the screen and repeats the steps from Step S102.

In the main routine, processes other than the scroll subroutine, such as an animation process or a network process, may be introduced before or after the scroll subroutine in Step S103. The scroll subroutine may be invoked from the main routine, for example, when a certain hardware interruption occurs or at a certain time interval. Although one controller is used in the following embodiments, use of two or more controllers may be permitted in some applications. In such cases, the scroll subroutine in Step S103 is invoked as many times as the number of the controllers to repeat the routine.

Exemplary scroll subroutines in the image display processing apparatus according to embodiments of the present invention will now be described.

First Embodiment of the Scrolling Method

A scrolling method by horizontally tilting (rolling) a controller, as in a case in which a child plays with dolls, will be described in the first embodiment. By using a humanoid controller or an animal-shaped controller, it appears as if the controller is walking on a display. Such a scrolling method is referred to as a “walking-type scrolling method”. The scrolling method of this embodiment uses tilt information of the controller as the attitude thereof.

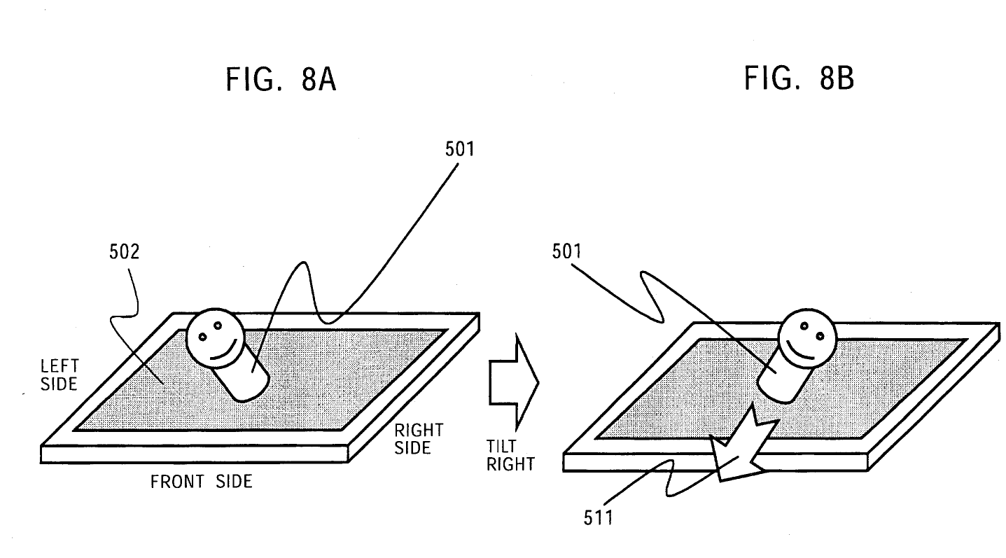

The following description is a case of a user enjoying an application using a humanoid controller 501 on a display 502. The humanoid controller has a face drawn on a front side, as shown in FIGS. 8A and 8B. Referring to FIG. 8A, the controller 501 is tilting left when viewing from the front side thereof. When the controller 501 tilts right at an angle that is equal to or greater than a threshold value, as shown in FIG. 8B, the display is scrolled toward the front side 511. In other words, a control unit controls the controller so that the controller scrolls the display 502 for a certain distance toward the front side 511 of the controller 501.

In this first embodiment, the scroll information generator 312 determines whether the controller 501 is tilted left (hereinafter referred to as a “left-tilting state”), is tilted right (hereinafter referred to as a “right-tilting state”), or is standing vertically (hereinafter referred to as a “vertical state”) based on the conversion information from the controller position-and-attitude-information converter 311 in the control unit 310 in FIG. 6.

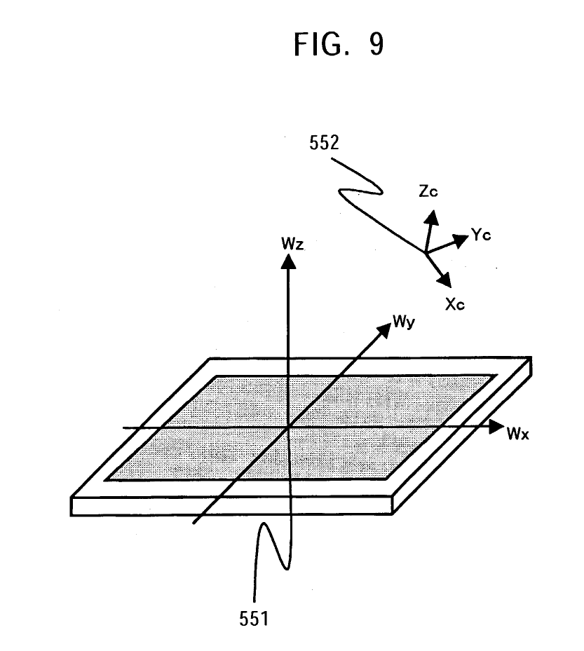

The method of calculating the tilt angle of the controller 501, the method being executed as a conversion process by the controller position-and-attitude-information converter 311, will now be described. First, the coordinate system required for the tilt calculation will be described with reference to FIG. 9. A screen coordinate system 551 defines the x-y plane that is parallel with the display and the z axis that is perpendicular to the display. A coordinate system for representing the position and attitude of a controller in the screen coordinate system 551 is referred to as a local coordinate system 552 of the controller. The position and attitude of the controller hereinafter means the position and attitude represented in the screen coordinate system 551.

The local coordinate system 552 of the controller is used to represent the position and attitude of the controller in the screen coordinate system 551. The Xc axis in the local coordinate system 552 defines the front direction of the controller, the Yc axis defines the left direction thereof, and the Zc axis defines the upward direction thereof. A rotation angle Zrot between the Xc axis and the z axis in the screen coordinate system 551 of the controller will be calculated.

The rotation angle Zrot is calculated by the following equation:

Zrot=tan−1 (V1y/V1x) (1)

where V1 [V1x, V1y, V1z] represents a vector having a length in the Xc direction.

The local coordinate system 552 of the controller is rotated by −Zrot with respect to the z axis in the screen coordinate system 551. This rotation makes the Xc axis in the local coordinate system 552 of the controller parallel with the x-z plane in the screen coordinate system 551. The local coordinate system of the controller at this time is defined as [Xc′, Yc′, Zc′].

The angle between the Zc′ in the new local coordinate system of the controller and the x-z plane in the screen coordinate system 551 will be calculated. A rotation angle Xrot is calculated by the following equation:

Xrot=tan−1 (V2y/V2x) (2)

where V2 [V2x, V2y, V2z] represents a vector having a length of any value in the Zc′ direction.

The rotation angle Xrot calculated by the equation (2) is defined as the tilt of the controller. When the tilt angle is greater than a predetermined range, the controller is in the right-tilting state; when it is smaller than the predetermined range, the controller is in the left-tilting state; and the controller otherwise is in the vertical state. Specifically, for example, when the rotation angle is greater than or equal to +30°, the controller is in the right-tilting state; when the it is less than or equal to −30°, the controller is in the left-tilting state; and when it is within ±30°, the controller is in the vertical state.

The controller position-and-attitude-information converter 311 in the control unit 310 in FIG. 6 calculates the tilt angle based on the information input from the position and attitude sensor 302. The scroll information generator 312 determines whether the controller is in the left-tilting state, in the right-tilting state, or in the vertical state based on the calculated tilt angle and determines whether the scrolling is performed and a scrolling mode if the scrolling is performed based on the determination of the tilt state. A tilt state may be determined as the basis of a predetermined value (for example, 30°), as described above, or as the basis of a value dynamically changing depending on situations.

Although the rotation angle toward the Xc axis (rolling direction) of the controller is given in the above calculation, a rotation angle toward the Zc axis (yaw) or the Yc axis (pitch) may be used to determine a tilt state. The tilt state of the controller can be determined by various methods other than the above-described one.

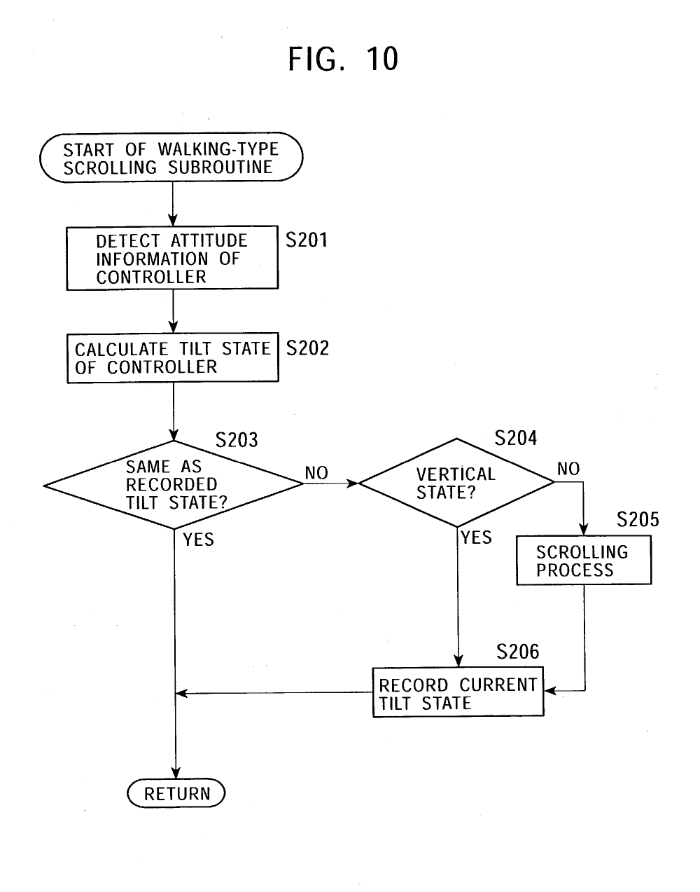

FIG. 10 is a flowchart of a scrolling method based on the tilt state of the controller, the process being performed in the image display processing apparatus according to the embodiment of the present invention. This flowchart shows an example of the scroll subroutine in Step S103 in the main routine described above with reference to FIG. 7.

In this scroll subroutine, the tilt state of a controller determined in the subroutine previously executed must be recorded. However, for a case in which no subroutine is previously executed and this subroutine is invoked for the first time, the tilt state is initialized to be the vertical state in the initialization step (S101) in the main routine in FIG. 7.

Referring to FIG. 10, in Step S201, the subroutine detects the current attitude of a controller. In Step S202, the subroutine calculates a current tilt state of the controller based on the detected attitude by using the method of calculating and processing the tilt angle of the controller from the attitude described above.

The tilt state is defined as one of the right-tilting state, the left-tilting state, and the vertical state. In Step S203, the subroutine compares the current tilt state of the controller with the tilt state recorded in the subroutine previously executed or the initial value if no information is recorded.

When the current tilt state of the controller is the same as the recorded tilt state, that is, when no state transition occurs and the same tilt state as the recorded one is maintained, the subroutine terminates. When the current tilt state of the controller is different from the recorded tilt state, the subroutine proceeds to Step S204.

In Step S204, when the current tilt state of the controller is the vertical state, that is, when the rotation angle is within the range between two predetermined threshold values (for example, between −30° and +30°), the subroutine proceeds to Step S206 to record the current tilt state for the next invocation of this subroutine and terminates. When the subroutine determines in Step S204 that the tilt state is the right-tilting state or the left-tilting state, in Step S205, the subroutine scrolls through the displayed image. In Step S206, the subroutine records the current tilt state and terminates.

The scrolling process in Step S205 is performed in the scroll information generator 312 and the screen display controller 313 in the control unit 310 in FIG. 6. Namely, the scroll information generator 312 determines whether the scrolling is performed and a scrolling mode if the scrolling is performed. The screen display controller 313 updates the information displayed on the screen based on the information determined by the scroll information generator 312.

The scroll direction can be arbitrarily determined. For example, as in the example described with reference to FIG. 8, the controller may scroll through the image toward the front thereof. In this case, the scrolling is performed toward the front of the controller, that is, along the Xc axis in the local coordinate system of the controller in FIG. 9. For example, when a three-dimensional image is displayed on the screen, three-dimensional scrolling is performed along the Xc axis.

Alternatively, when a two-dimensional image in the x-y plane is displayed on the screen and only two-dimensional scrolling can be performed, the scrolling may be performed toward the front side of the controller. Namely, the scrolling may be performed along the Xc axis in the local coordinate system of the controller shown in FIG. 9, that is projected on the x-y plane in the screen coordinate system, that is, the scrolling may be performed in a two-dimensional direction on the x-y plane in the screen coordinate system. In such a case, the scroll direction is set to [V3x, V3y, 0] where a vector V3 in the Xc direction in the screen coordinate system equals [V3x, V3y, V3z]. It appears as if the controller is advancing toward the front side thereof.

The scroll distance in one scrolling process, or the scroll speed, may be empirically determined, may be set to a default value, or may be dynamically changed in accordance with other elements. In the first embodiment of the scrolling method, the controller may instantly scroll through the image for a desired distance in response to, for example, only one invocation of the subroutine or it may gradually and smoothly scroll through the image, for example, during several invocations of the subroutine. The effective scroll range is usually determined and no scrolling is performed beyond the range.

The scroll information generator 312 in the control unit 310 in FIG. 6 determines the scroll direction, the scroll distance, and the scroll speed based on the information from the controller position-and-attitude-information converter 311, that is, based on the information provided by comparison of the current tilt state of the controller with the previous tilt state of the controller. Alternatively, the screen display controller 313 updates the image on the display by using the default data as the determined information.

Processes performed by the screen display controller 313 in the control unit 310 in the scrolling process in Step S205 includes conversion of projection matrix or conversion in a world coordinate system for a three-dimensional CG (computer graphics) and includes offset of drawing positions or change of scale for a two-dimensional CG.

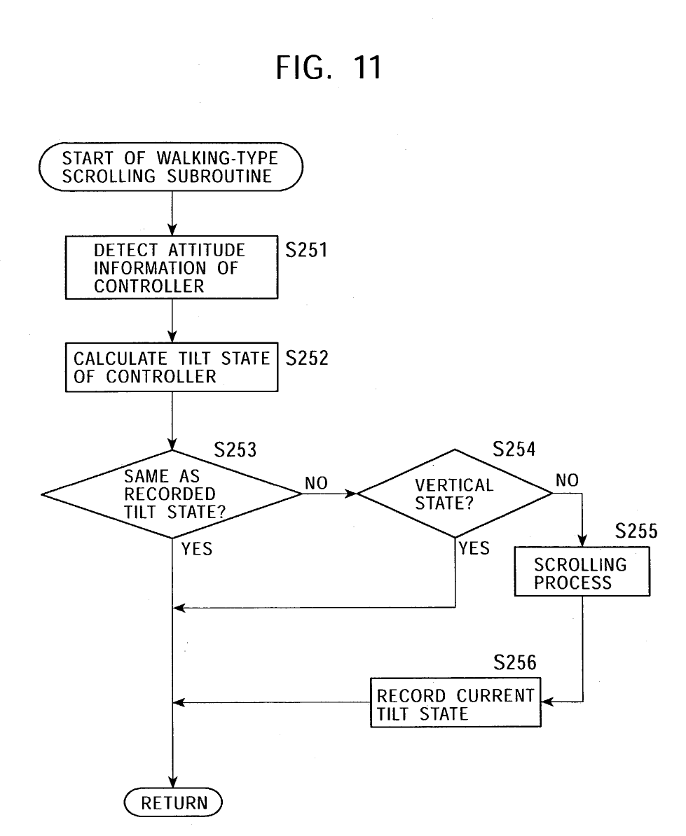

As described above, in the subroutine shown in FIG. 10, the scrolling is performed when the controller changes its tilt state from tilt states other than the left-tilting state to the left-tilting state or from tilt states other than the right-tilting state to the right-tilting state. In other words, the scrolling is performed when the controller changes its tilt state from the left-tilting state through the vertical state to the left-tilting state. However, without recorded vertical states, the scrolling may be performed only when the tilt state changes from the right-tilting state to the left-tilting state or from the left-tilting state to the right-tilting state. This prevents the controller from scrolling more than necessary even when the tilt angle fluctuates around the threshold value owing to the precision of the sensor. The subroutine in such a case will be described with reference to FIG. 11.

Referring to FIG. 11, in Step S251, the subroutine detects the current attitude of a controller. In Step S252, the subroutine calculates a current tilt state of the controller based on the detected attitude by using the method of calculating and processing the tilt angle of the controller from the attitude, described above.

The tilt state is defined as one of the right-tilting state, the left-tilting state, and the vertical state. In Step S253, the subroutine compares the current tilt state of the controller with the tilt state recorded in the subroutine previously executed or the initial value if no information is recorded.

When the current tilt state of the controller is the same as the recorded tilt state, that is, when no state transition occurs and the same tilt state as the recorded one is maintained, the subroutine terminates. When the current tilt state of the controller is different from the recorded tilt state, the subroutine proceeds to Step S254. When the subroutine determines in Step S254 that the current tilt state of the controller is the left-tilting state or the right-tilting state, in Step S255, the subroutine performs the scrolling through the displayed image. In Step S256, the subroutine records the current tilt state of the controller and terminates.

When the subroutine determines that the current tilt state of the controller is the vertical state in Step S254, that is, when the rotation angle is within the range between two predetermined threshold values (for example, between −30° and +30° ), the subroutine terminates.

This subroutine differs in this step from the subroutine described above with reference to FIG. 10. The vertical state is recorded in the subroutine described above, whereas the vertical state is not recorded in this subroutine. Without a recorded vertical state, as in this subroutine, the scrolling is performed only when the controller changes its tilt state from the right-tilting state to the left-tilting state or from the left-tilting state to the right-tilting state. This prevents the controller from scrolling more than necessary even when the tilt angle fluctuates around the threshold value owing to the precision of the sensor.

Second Embodiment of the Scrolling Method

In the second embodiment, scrolling is performed when the controller is positioned within a predetermined area in the screen coordinate system. This predetermined area is referred to as an “active area” and the scrolling method of this embodiment is referred to as an “area-type scrolling method”. Although only the position of the controller is used to determine whether the scrolling is performed in this embodiment, the attitude may also be used in the scrolling method to determine a scrolling mode.

The scrolling method of the second embodiment may be combined with that of the first embodiment. In the combination process, the process determines whether the scrolling is performed in accordance with whether the controller is within the active area. The scrolling is performed based on a state transition between the right-tilting state, the left-tilting state, and the vertical state only when the controller is within the active area.

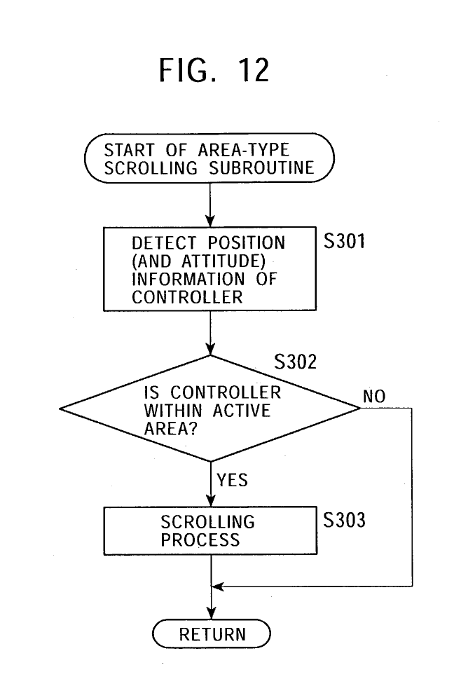

FIG. 12 is a flowchart of a scrolling method based on the information on the controller according to the second embodiment. This flowchart shows an example of the scroll subroutine in Step S103 in the main routine described above with reference to FIG. 7. First, in Step S301, the subroutine detects the position and, if required, attitude of a controller.

In Step S302, the subroutine determines whether the position of the controller detected in Step S301 is within the active area. The determination in Step S302 is performed in the scroll information generator 312 in the control unit 301 in FIG. 6. The scroll information generator 312 has information concerning a predetermined active area and compares the position of the controller supplied from the controller position-and-attitude-information converter 311 with the active area information to determine whether the controller is within the active area. When the controller is not within the active area, the subroutine terminates. When the subroutine determines in Step S302 that the controller is within the active area, in Step S303, the scrolling is performed.

The shape and size of the active area and the scroll direction and speed may be arbitrarily set in this embodiment. Examples of the shape of the active area and examples of the scroll direction and speed will be described.

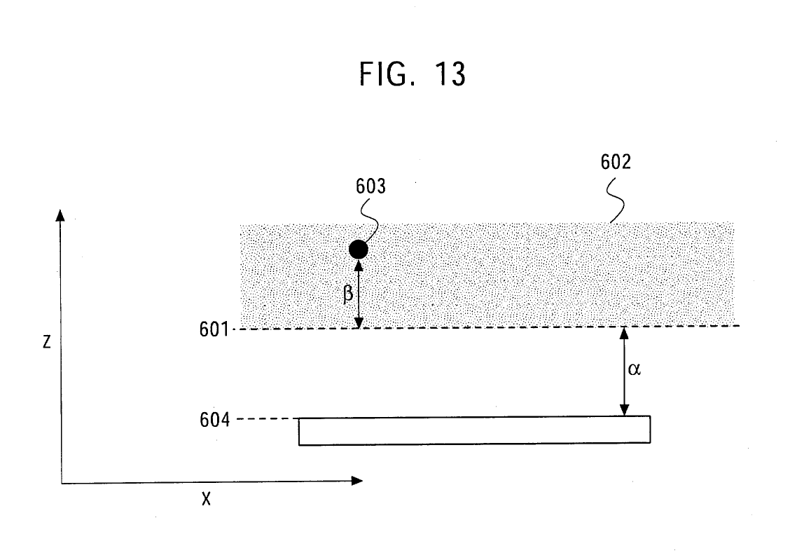

FIG. 13 is a diagram showing an example of the set active area. A display 604 is arranged in parallel with the horizontal direction (x-y plane) and an active area 602 is set above the display 604 (along the z axis). The active area 602 is arranged so that the scrolling is performed when a controller 603 is spaced apart, in the vertical direction, from the display 604 by a distance more than α.

An active area boundary 601 that forms a boundary between the active area and a non-active area is a plane that is parallel with the display 604 and is spaced apart, in the vertical direction, from the display 604 by a distance α. A space that is spaced apart, in the vertical direction, from the display 604 by a distance more than α is defined as the active area 602. When a user scrolls through the image on the display 604, he/she should detach the controller from the display 604 by a distance more than α.

In such an active area, the scrolling may be performed three-dimensionally toward the front of the controller or may be performed two-dimensionally toward the front side of the controller (the Xc axis in the local coordinate system in FIG. 9), the Xc axis being projected on the plane parallel with the display (the x-y plane in the screen coordinate system in FIG. 9). The scroll speed may be set to a certain empirical value or may vary depending on the position and attitude of the controller.

For example, when the controller is spaced apart, in the vertical direction, from the active area boundary 601 by a distance β, as shown in FIG. 13, the scroll speed, or the travelling speed on the display is set to k1β (k1 is a proportional constant and may be empirically set to any value). That is, the scroll speed (Vs) is given by the following equation:

Vs=k1β

The scroll distance, or the distance on the display by which the controller moves in one scrolling process is set to k2β (k2 is a proportional constant and may be empirically set to any value). That is, the scroll distance (Vv) is given by the following equation:

Vv=k2β

Alternatively, the image display processing apparatus can be structured so that the smaller the angle between the display and the front side of the controller is, the higher the scroll speed is. In other words, the scroll speed may be set to k3 cos θ(k3 is a proportional constant and may be empirically set to any value) where θ indicates an angle between the x-y plane in the screen coordinate system and the Xc axis of the controller in the local coordinate system. That is, the scroll speed (Vs) is given by the following equation:

Vs=k3 cos θ

The scroll distance may be set to k4 cos θ (k4 is a proportional constant and may be empirically set to any value). That is, the scroll distance (Vv) is given by the following equation:

Vv=k4 cos θ

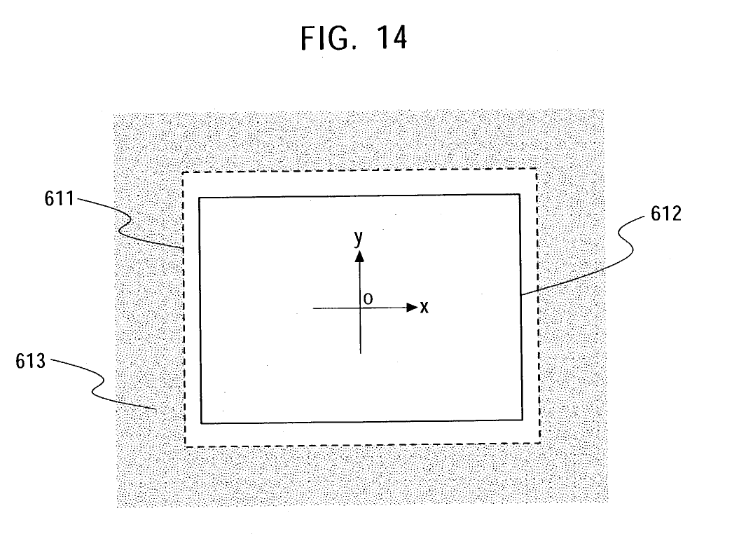

An exemplary area-type scrolling method in which the scrolling is performed when the controller is near the ends of the display or outside the display will be described with reference to FIG. 14. FIG. 14 is a diagram when viewing from the top of the display, in which an active area boundary 611 is one size larger than a display frame 612. An active area 613 is around the display frame 612.

The active area boundary 611 may be congruent with the display frame 612 or may be set inside the display frame. In such cases, a user moves the controller outside the active area boundary 611 for scrolling.

The scroll direction in this active area 613 may be limited to the x direction or y direction in the screen coordinate system 551 in FIG. 9 or may be toward the controller from the center of the display. The scroll speed may be set to a predetermined value or may vary depending on the distances from the ends of the display or the distance from the center of the display. For example, the image display processing apparatus can be structured so that the further away from the ends of the display the controller is, the higher the scroll speed is.

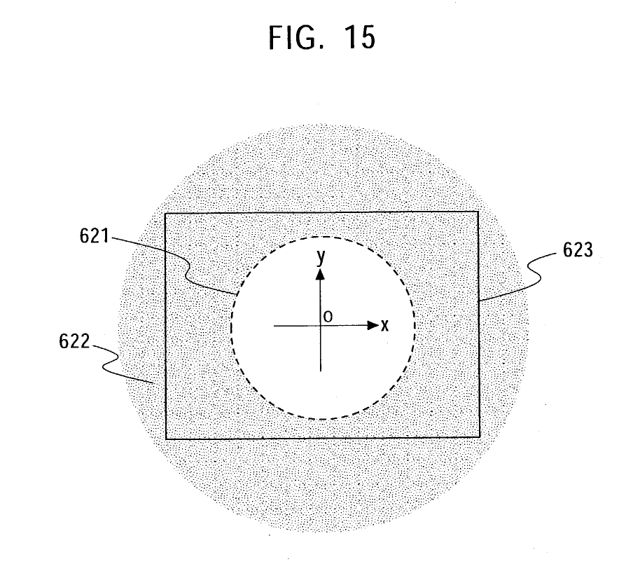

An exemplary area-type scrolling method in which an active area is determined depending on the distance between the position of the controller and the center of the display will be described with reference to FIG. 15. FIG. 15 is a diagram when viewing from the top of the display, in which an active area boundary 621 is drawn as a circle having a certain radius from the center of the display and the area outside this circle is an active area 622.

The scroll direction in this active area 622 may also be limited to the x direction or y direction in the screen coordinate system 551 in FIG. 9 or may be toward the controller from the center of the display, as in FIG. 14. The scroll speed may be set to a predetermined value or may vary depending on the distance from the center of the display. For example, the image display processing apparatus can be structured so that the further away from the center of the display the controller is, the higher the scroll speed is.

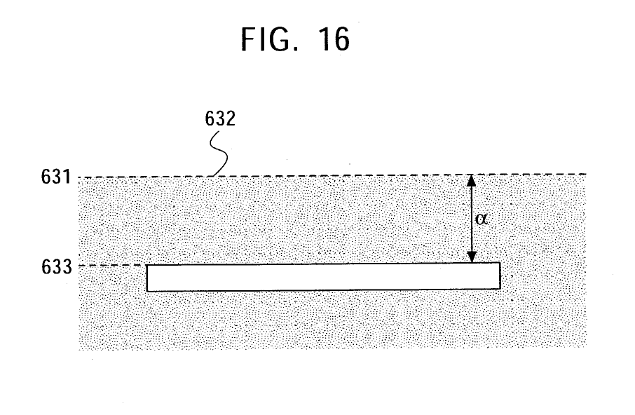

With an active area 632 structured as in FIG. 16, the scrolling method in which a controller is dragged on the display can be realized as an example of the area-type scrolling method.

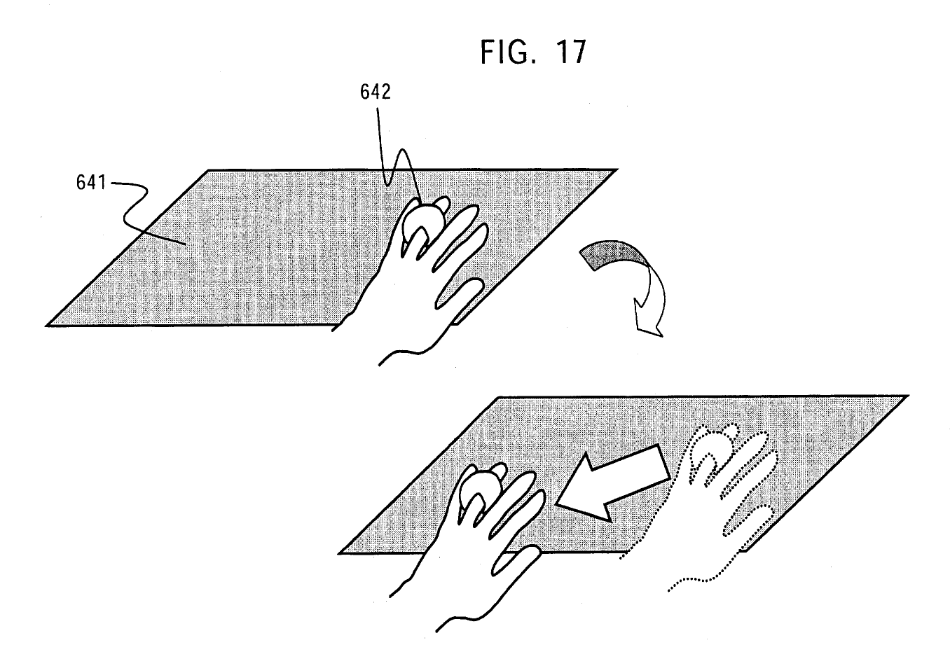

The active area 632 is defined within a predetermined vertical distance α from a display 633, as shown in FIG. 16, this case being opposite to the case in FIG. 13. When a controller is within the active area 632 between an active area boundary 631 and the display 633, the two-dimensional scrolling through the image is performed in accordance with the position of the controller. For example, when the scrolling through an image on a display 641 is performed with a ring-shaped controller 642 as in FIG. 17, the controller can scroll through the image on the display 641 as if the controller moves on a sheet of paper.

Third Embodiment of the Scrolling Method

In the third embodiment of the scrolling method, a controller directly interacts with objects on a display. When the controller is positioned within an area (also referred to as an “active area”) defined based on the position and attitude of the objects, such as a car or an airplane, on the display, the scrolling is performed. This scrolling method is referred to as a “vehicle-type scrolling method”. The active area may have any shape. Although only the position of the controller is used to determine whether the scrolling is performed in this embodiment, the attitude may also be used in the scrolling method to determine a scrolling mode.

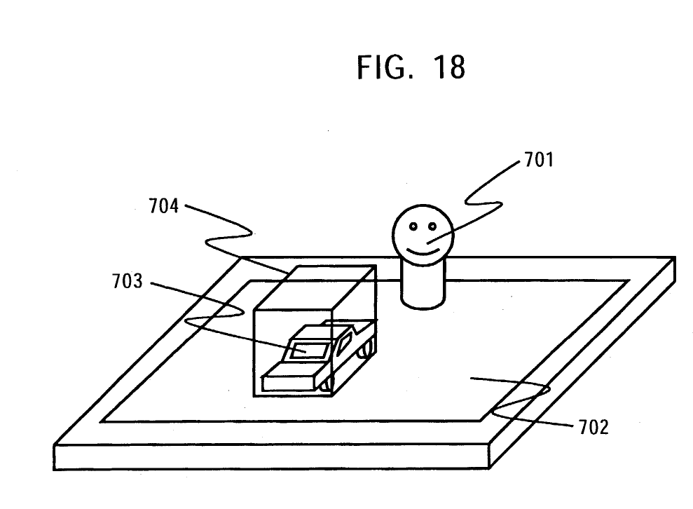

An exemplary scrolling method is shown in FIG. 18. A rectangular active area 704 is defined around a virtual car 703 in a three-dimensional virtual world on a display 702 based on the position and attitude of the car 703 on the display 702. The active area 704 is updated in accordance with the update of the display position and attitude of the car 703. When a user moves a controller 701 into the active area 704, the two-dimensional scrolling through the image on the display 702 is performed toward the front side of the controller 701.

The position and attitude of the car 703 is determined in accordance with the position and attitude of the controller 701 during scrolling, so that it appears as if the controller 701 is moving aboard the car 703. Since the position of the active area 704 is determined based on the position of the car 703 on the display 702, the active area 704 does not vertically move with respect to the display 702. Hence, when the scrolling stops, that is, when a user wants to get off the car 703, the controller is detached from the display 702.

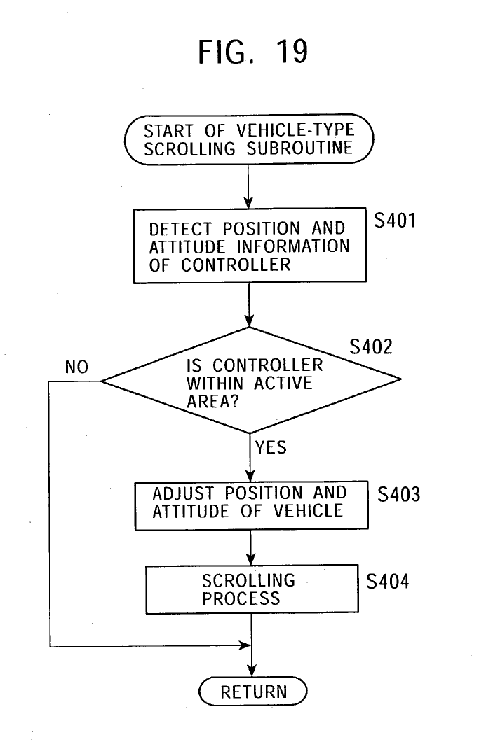

FIG. 19 is a flowchart of a scrolling method according to the third embodiment of the present invention. This flowchart shows an example of the scroll subroutine in Step S103 in the main routine described above with reference to FIG. 7.

In Step S401, the subroutine detects the position and attitude of a controller. In Step S402, the subroutine determines whether the controller is within the active area. The determination in Step S402 is performed in the scroll information generator 312 in the control unit 310 in FIG. 6. The scroll information generator 312 has information concerning a predetermined active area and compares the position of the controller supplied from the controller position-and-attitude-information converter 311 with the active area information to determine whether the controller is within the active area.

When the subroutine determines that the controller is within the active area in Step S402, the subroutine proceeds to Step S403. When the determination in Step S402 is negative, the subroutine terminates.

In Step S403, the subroutine adjusts the position and attitude of the vehicle based on the position and attitude of the controller in order to exhibit the controller as if it is getting on the vehicle. Specifically, the position and attitude of the vehicle may be displayed in correspondence with the position and attitude of the controller or the position and attitude of the vehicle may be offset from the position and attitude of the controller for display. In Step S404, the subroutine performs the scrolling and terminates.

The scrolling process may three-dimensionally performed toward the front side of the controller or may two-dimensionally performed toward the front side of the controller (the Xc axis in the local coordinate system in FIG. 9), the Xc axis being projected on the plane parallel with the display. Alternatively, three-dimensional scrolling that follows the shape of the land in a three-dimensional virtual world may be performed. The scroll speed may be set to a predetermined value or may dynamically varied, as in the embodiments described above. For example, the scrolling through the image along a predetermined path to a certain position is performed, like a ship moving from one harbor to another harbor.

Fourth Embodiment of the Scrolling Method

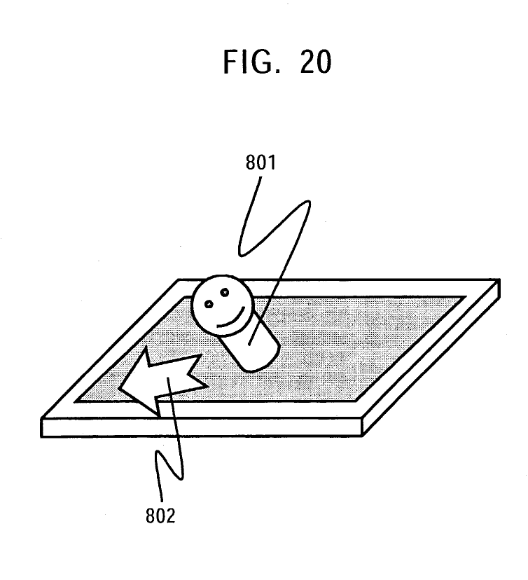

A method of scrolling through an image by tilting a controller, as in a case of joystick operation, will be described in the fourth embodiment. Referring to FIG. 20, the scrolling is performed toward the direction 802 of a tilting controller 801. Such a scrolling method is referred to as a “joystick-type scrolling method”. Only the attitude of the controller is used and only two-dimensional scrolling can be performed in this embodiment.

The tilt information is determined from the attitude of the controller in the fourth embodiment. The tilt information according to this embodiment indicates how and to which direction the Zc axis in the local coordinate system of the controller (FIG. 9) tilts with respect to the z axis in the screen coordinate system (FIG. 9). The tilt information can be easily determined from a vector V that is given by projecting a unit vector of the controller along the Zc axis on the x-y plane in the screen coordinate system. The length of the vector V equals sin θ where θ indicates the tilt angle.

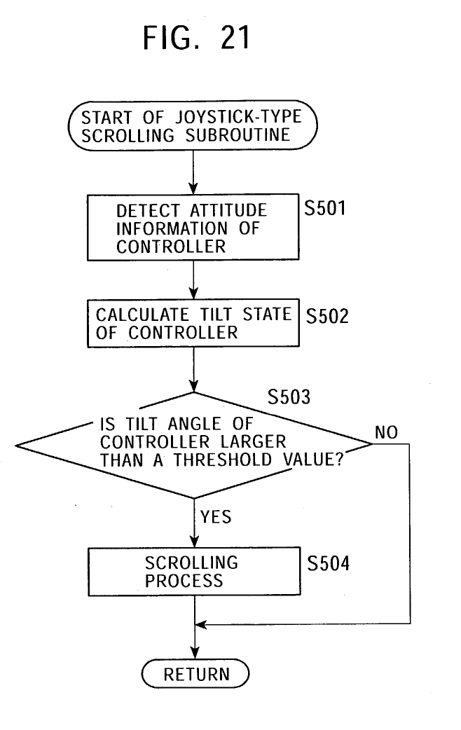

FIG. 21 is a flowchart of a scrolling method according to the fourth embodiment of the present invention. This flowchart shows an example of the scroll subroutine in Step S103 in the main routine described above with reference to FIG. 7.

In Step S501, the subroutine detects the attitude of a controller. In Step S502, the subroutine calculates a tilt state of the controller based on the detected attitude by using the method of calculating and processing the tilt angle of the controller from the attitude described above. The tilt calculation here is performed in the controller position-and-attitude-information converter 311 in the control unit 310 in FIG. 6.

In Step S503, the subroutine determines whether the calculated tilt angle of the controller is larger than a threshold value. When the tilt angle of the controller is larger than the threshold value, in Step S504, the scrolling is performed. When the tilt angle of the controller is smaller than the threshold value, the subroutine terminates.

The scrolling can be performed in various modes in Step S504. For example, the scrolling toward the direction of the tilting controller may be performed; in this case, it appears as if the controller is moving toward the tilt direction thereof on the display. The scroll distance may be set to any value or may vary depending on, for example, the tilt angle. For example, the larger the tilt angle, the higher the scroll speed is. The determination of the tilt angle of the controller in Step S503 may be omitted. If Step S503 is omitted, the scrolling is performed if the controller tilts only slightly.

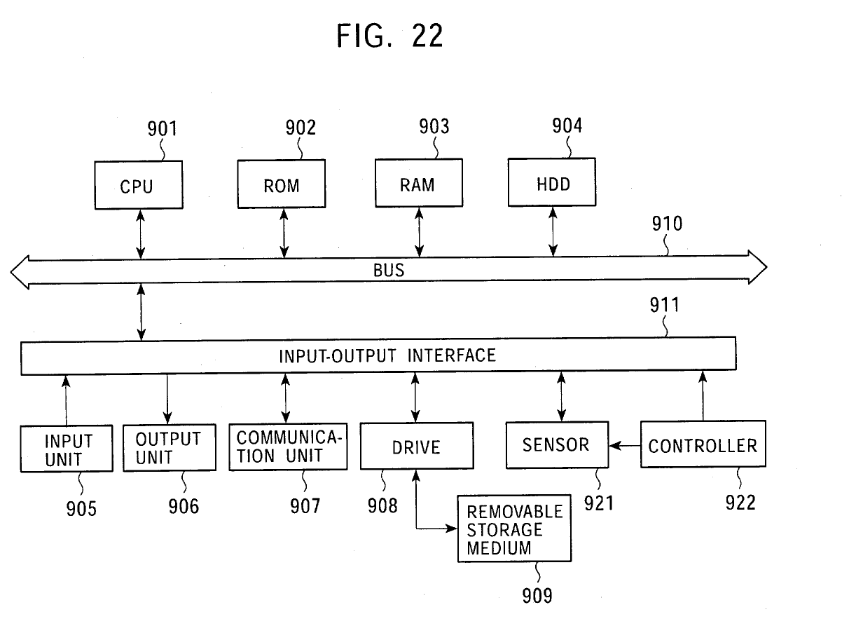

FIG. 22 is a block diagram showing the hardware configuration of an image display processing apparatus of the present invention. The image display processing apparatus includes a CPU (central processing unit) 901, a ROM (read only memory) 902, a RAM (random access memory) 903, and an HDD (hard disk drive) 904. The CPU 901 executes various application programs and an OS (operating system). The ROM 902 stores programs executed by the CPU 901 or fixed data functioning as arithmetic parameters. The RAM 903 is a storage area and a work area for programs executed in the CPU 901 and variable parameters in the programs. The HDD 904 controls the hard disk, and stores various data and programs into the hard disk and reads them from the hard disk.

The image display processing apparatus also includes a bus 910 including a PCI (peripheral component interconnect) bus. The bus 910 exchanges data with each input-output apparatus through various modules and an input-output interface 911.

The image display processing apparatus further includes an input unit 905 including a keyboard, a pointing device, and the like and an output unit 906. The input unit 905 is operated by a user to supply various commands and data to the CPU 901. The output unit 906 is, for example, a CRT (cathode ray tube) or a liquid crystal display for displaying the image scrolled through and displays various information as texts, images, or the like.

The image display processing apparatus further includes a communication unit 907, a drive 908, and a removable storage medium 909. The communication unit 907 communicates with other devices. The drive 908 plays back programs or data from the removable storage medium 909, such as a flexible disc, a CD-ROM (compact disc read only memory), an MO (magnetic optical) disc, a DVD (digital versatile disc), a magnetic disc, or a semiconductor memory, and stores programs or data in the removable storage medium 909.

The image display processing apparatus further includes a sensor 921 and a controller 922. The sensor 921 is a camera, a magnetic sensor, an ultrasonic sensor, or the like, as described above. The sensor 921 detects the position and/or attitude of the controller 922.

During the scrolling process, the CPU 901 determines a scrolling mode based on the information input from the sensor 921 and the controller 922 in accordance with the program recorded on the storage medium, such as a ROM. The scrolling results are displayed on the output unit 906 serving as an image display device.

While the invention has been particularly shown and described with reference to preferred embodiments thereof, it will be understood by those skilled in the art that the foregoing and other changes in form and details can be made therein without departing from the spirit and scope of the present invention. The scope of the invention is therefore to be determined solely by the appended claims.

A series of processing described above may be implemented by hardware, by software, or combination of both hardware and software. When a series of processing by software is implemented, programs having processing sequences recorded may be installed and executed in a memory in a computer, the memory being incorporated in dedicated hardware, or may be installed and executed in a general-purpose computer in which various kinds of processing can be performed.

For example, the programs may be recorded in advance in a hard disc or a ROM serving as a storage medium. Alternatively, they may be temporarily or permanently stored in a removable storage medium, such as a flexible disc, a CD-ROM, an MO disc, a DVD, a magnetic disc, or a semiconductor memory. Such a removable storage medium can be supplied as package software.

The programs may not only be installed in the computer from the removable storage medium described above, but also be subject to wireless transmission from a download site to a computer or to wired transmission through a network, such as a LAN (local area network) or the Internet, to a computer. In the latter case, the computer receives the transmitted programs and installs them in a built-in storage medium such as a hard disk.

The various kinds of processing described above may be executed in time series in the order of description or may be executed in parallel or distinctly depending on the processing capacity of an processor or if required.

What is claimed is:

1. An image display processing apparatus for scrolling through an image on a display, the apparatus comprising:
a controller unit including a controller that is operable by a user and a sensor that detects position and/or attitude of the controller in a three-dimensional space;
a scroll information generator for determining a scrolling mode of the image on the display based on the position and/or attitude of the controller in the three-dimensional space; and
an image display controller for scrolling through the image on the display in accordance with the scrolling mode determined in the scroll information generator to update the displayed image.

2. An image display processing apparatus according to claim 1, wherein the scroll information generator determines whether the controller is in a right-tilting state, a left-tilting state, or a vertical state and determines whether scrolling is performed based on the presence of a state transition between the three states.

3. An image display processing apparatus according to claim 1, wherein the scroll information generator determines whether the controller is in a right-tilting state, a left-tilting state, or a vertical state and determines whether scrolling is performed based on the presence of a state transition between the right-tilting state and the left-tilting state.

4. An image display processing apparatus according to claim 1, further comprising a converter for converting the position and/or attitude of the controller into information corresponding to a screen coordinate system with respect to the surface of the display,
wherein the scroll information generator determines the scrolling mode of the image on the display based on the converted position and/or attitude of the controller in the screen coordinate system.

5. An image display processing apparatus according to claim 1, wherein the scroll information generator determines a scroll direction based on an orientation of the controller.

6. An image display processing apparatus according to claim 1, wherein the scroll information generator determines a scroll direction based on a tilt direction of the controller.

7. An image display processing apparatus according to claim 1, wherein the scroll information generator determines whether the controller is within a predetermined active area and determines to perform scrolling when the controller is within the predetermined active area.

8. An image display processing apparatus according to claim 7, wherein the active area is defined as an area that is spaced apart, in the vertical direction, from the surface of the display by a distance greater than a predetermined distance.

9. An image display processing apparatus according to claim 7, wherein the active area is defined as an area that is spaced apart, in the horizontal direction, from the surface of the display by a distance greater than a predetermined distance.

10. An image display processing apparatus according to claim 7, wherein the active area is defined as an area that is spaced apart from the center of the display by a distance greater than a predetermined distance.

11. An image display processing apparatus according to claim 7, wherein the active area is defined as an area that is within a predetermined distance from the display.

12. An image display processing apparatus according to claim 7, wherein the active area is defined as an area in the three-dimensional space corresponding to the image on the display.

13. An image display processing apparatus according to claim 7, wherein the scroll information generator determines a scroll speed or a scroll distance based on the position and/or attitude of the controller within the active area.

14. An image display processing apparatus according to claim 1, wherein the sensor is either an imaging system, a magnetic sensor, or an ultrasonic sensor.

15. An image display processing method for scrolling through an image on a display, the processing method comprising:
a step of detecting position and/or attitude of a controller in a three-dimensional space by a sensor, the controller being operated by a user;
a scroll information generating step of determining a scrolling mode of the image on the display based on the position and/or attitude of the controller in the three-dimensional space; and
an image display control step of scrolling through the image on the display in accordance with the scrolling mode determined in the scroll information generating step to update the displayed image.

16. An image display processing method according to claim 15, wherein the scroll information generating step includes a step of determining whether the controller is in a right-tilting state, a left-tilting state, or a vertical state and determining whether scrolling is performed based on the presence of a state transition between the three states.

17. An image display processing method according to claim 15, wherein the scroll information generating step includes a step of determining whether the controller is in a right-tilting state, a left-tilting state, or a vertical state and determining whether scrolling is performed based on the presence of a state transition between the right-tilting state and the left-tilting state.

18. An image display processing method according to claim 15, further comprising a converting step of converting the position and/or attitude of the controller into information corresponding to a screen coordinate system with respect to the surface of the display,
wherein the scroll information generating step determines the scrolling mode of the image on the display based on the converted position and/or attitude of the controller in the screen coordinate system.

19. An image display processing method according to claim 15, wherein the scroll information generating step includes a step of determining a scroll direction based on an orientation of the controller.

20. An image display processing method according to claim 15, wherein the scroll information generating step includes a step of determining a scroll direction based on a tilt direction of the controller.

21. An image display processing method according to claim 15, wherein the scroll information generating step determines whether the controller is within a predetermined active area and determines to perform scrolling when the controller is within the predetermined active area.

22. An image display processing method according to claim 21, wherein the active area is defined as an area that is spaced apart, in the vertical direction, from the surface of the display by a distance greater than a predetermined distance.

23. An image display processing method according to claim 21, wherein the active area is defined as an area that is spaced apart, in the horizontal direction, from the surface of the display by a distance greater than a predetermined distance.

24. An image display processing method according to claim 21, wherein the active area is defined as an area that is spaced apart from the center of the display by a distance greater than a predetermined distance.

25. An image display processing method according to claim 21, wherein the active area is defined as an area that is within a predetermined distance from the display.

26. An image display processing method according to claim 21, wherein the active area is defined as an area in the three-dimensional space corresponding to the image on the display.

27. An image display processing method according to claim 21, wherein the scroll information generating step includes a step of determining a scroll speed or a scroll distance based on the position and/or attitude of the controller within the active area.

28. An image display processing method according to claim 15, wherein the sensor is either an imaging system, a magnetic sensor, or an ultrasonic sensor.

29. A computer program for rendering a computer system to perform scrolling through an image on a display, the computer program comprising:
a step of detecting position and/or attitude of a controller in a three-dimensional space by a sensor, the controller being operated by a user;
a scroll information generating step of determining a scrolling mode of the image on the display based on the position and/or attitude of the controller in the three-dimensional space; and
an image display control step of scrolling through the image on the display in accordance with the scrolling mode determined in the scroll information generating step to update the displayed image.
